(19) United States
(12) Patent Application Publication
(10) Pub. No.: US 2015/0319456 A1
(43) Pub. Date: Nov. 5, 2015

(54) Method and device for encoding a sub-aperture image of a set of sub-aperture images obtained from a plenoptic image

(71) Applicant: CANON KABUSHIKI KAISHA, Tokyo (JP)

(72) Inventor: HERVÉ LE FLOCH, RENNES (FR)

(21) Appl. No.: 14/698,688

(22) Filed: Apr. 28, 2015

(30) Foreign Application Priority Data
Apr. 30, 2014 (GB) 1407631.9

(51) Int. Cl. H04N 19/587; H04N 19/119; H04N 19/136; H04N 19/102

(52) U.S. Cl. CPC H04N 19/587; H04N 19/102; H04N 19/119; H04N 19/136

(57) ABSTRACT

The invention relates to a method for encoding a plenoptic image comprising a plurality of microlens images, each microlens image formed by an associated microlens, the plenoptic image being associated with acquisition parameters of a plenoptic acquisition system with which the plenoptic image has been obtained, the method comprising decomposing the plenoptic image into a plurality of sub-aperture images, and encoding said plurality of sub-aperture images using one or more encoding parameters, which one or more encoding parameters are determined in dependence upon the acquisition parameters associated with the plenoptic image.

The invention also relates to a corresponding device for encoding a plenoptic image.

This application claims the benefit under 35 U.S.C. §119(a)-(d) of the United Kingdom Patent Application No. 1407631.9 filed on Apr. 30, 2014 and entitled “Method and device for encoding a sub-aperture image of a set of sub-aperture images obtained from a plenoptic image”. The above cited application is incorporated herein by reference in its entirety.

### FIELD OF THE INVENTION

The invention relates to a method and device for processing light field images, also called plenoptic images. The invention relates more particularly to improve encoding of a digital plenoptic image, and may in particular be used to improve compression of a plenoptic image.

The processed image may notably be a plenoptic digital photograph, or an image of a plenoptic video sequence.

### BACKGROUND OF THE INVENTION

Plenoptic images are 2D images captured by an optical system different from conventional cameras. A plenoptic image can be refocused in a range of virtual focus planes after it is taken.

In a plenoptic system such as a plenoptic digital camera, an array of micro-lenses is located between the sensor and the main lens of the camera. Depending on the system, the array of micro-lenses may be placed at the focal plane of said main lens or so that the micro-lenses are focused on the focal plane of the main lens.

A given number of pixels of the sensor are located underneath each micro-lens. Through this micro-lens array, the sensor captures pixel values that are related to the location and the orientation of light rays inside the main lens. By processing the captured plenoptic images comprising such information, the displacement or “disparity” of image parts that are not in focus can be analyzed and depth information can be extracted. This makes it possible to change the focusing plane of the 2D image after the capture of the image, and thus to refocus the image, i.e. virtually change the focal plane of the image and/or extend or shorten the focal depth of the image. By changing the focusing point or plane, sharpness and blur on the objects located at different depths in the 3D scene can be modified on the 2D image.

This refocusing provides the advantage of generating different 2D images with different focusing points. It enables different camera parameters to be simulated, namely the lens aperture and the focal plane.

Theoretical aspects of plenoptic imaging are set out for example in the document “Digital Light Field Photography”, a dissertation submitted to the department of computer science and the committee on graduate studies of Stanford University in partial fulfillment of the requirements for the degree of doctor of philosophy” by Ren Ng, dated July 2006.

The document “Full Resolution Lightfield Rendering” by Andrew Lumsdaine and Todor Georgiev (January 2008, Adobe Systems Inc.) discloses an advanced plenoptic system.

The present invention relates to a method and device for processing, and more particularly for compressing plenoptic images.

Specific compression algorithms are used for compressing plenoptic images. Compression of light fields or plenoptic images is described in several documents. In particular, it is described in the documents U.S. Pat. No. 6,476,805, U.S. Pat. No. 8,103,111, and U.S. Pat. No. 8,155,456. These documents relate respectively to use of inter-coding, use of LZW compression, and block coding, in the context of plenoptic imaging.

The implemented compression algorithms may require important run times and/or hardware resources. The present invention aims at improving the compression of plenoptic images.

### SUMMARY OF THE INVENTION

According to a first aspect of the invention, there is provided a method for encoding a plenoptic image comprising a plurality of microlens images, each microlens image formed by an associated microlens, said plenoptic image being associated with acquisition parameters of a plenoptic acquisition system with which the plenoptic image has been obtained, the method comprising decomposing said plenoptic image into a plurality of sub-aperture images, and encoding said plurality of sub-aperture images using one or more encoding parameters, which encoding parameters are determined in dependence upon the acquisition parameters associated with the plenoptic image.

By drastically limiting the computation time to determine compression parameters used to encode plenoptic images depending on their acquisition parameters (e.g. images belonging to a particular category according to their acquisition parameters), this method makes it possible to decrease the total computation times for encoding a set of sub-apertures images while providing a compression ratio close to its optimal value.

The method may comprise classifying the plenoptic image into one of a plurality of categories by comparing the acquisition parameters with predetermined threshold parameters defining said categories. The threshold parameters may be determined empirically using training data. Advantageously, a first category is defined and the sub-aperture images of a plenoptic image of said first category are encoded using a rate-distortion optimization process to determine encoding parameters. A second category may also be defined and at least one sub-aperture image of a plenoptic image of said second category is encoded using a restricted sub-set of encoding parameters.

In a first variant of such a method, the sub-aperture images corresponding to a plenoptic image may be indexed to be encoded in an order defined by the index, and at least one sub-aperture image is encoded using encoding parameters determined for a lower indexed, sub-aperture image. The lower indexed sub-aperture image may be encoded using a rate-distortion optimization process to determine encoding parameters. The lower indexed sub-aperture image may in be the second indexed sub-aperture image.

In a second variant of such a method, the sub-aperture images may be indexed to be encoded in an order defined by the index, and the first indexed sub-aperture image is encoded using a rate-distortion optimization process to determine encoding parameters from a set of possible parameters, and at least one higher indexed sub-aperture image is encoded using parameters selected from a restricted sub-set of said possible parameters.

In a particular embodiment of the method, determining the encoding parameters comprises for each parameter to be determined:
determining, based on the category to which the plenoptic image belongs, a sub-set of possible encoding parameters based on the acquisition parameters;
determining the encoding parameter to be used for encoding in the determined subset.

In any embodiment, the encoding parameter may comprise the size of a search area for motion estimation.

The sub-aperture images may be encoded in blocks of pixels, a determined encoding parameter comprising an encoding mode of the blocks of pixels.

Pixel blocks may be independently encoded, a determined encoding parameter comprising a size of the blocks of pixels.

The block of pixels may be a prediction unit. The block of pixels may be a coding unit.

In a method according to the invention, the acquisition parameters may comprise an aperture of a lens of the acquisition system, and/or a focal length of a lens of the acquisition system, and/or the distance of the focusing plane from the acquisition system. In particular, the distance value of the focusing plane is determined using information provided by a camera autofocus system.

In a method according to the invention, a determined encoding parameter may be a compression parameter for inter image prediction with respect to another sub-aperture image of the plurality of sub-aperture images.

In a particular embodiment in which threshold parameters are determined, the determination of the threshold parameters comprises obtaining a statistical model of the distribution of values of the encoding parameter according to the rate/distortion performances of the encoding method, in dependence on the acquisition parameter values.

According to a second aspect of the invention, there is provided a device for encoding a plenoptic image comprising a plurality of microlens images, each microlens image formed by an associated microlens, said plenoptic image being associated with acquisition parameters of a plenoptic acquisition system with which the plenoptic image has been obtained, the device comprising means configured to decompose said plenoptic image into a plurality of sub-aperture images, and means configured to encode said plurality of sub-aperture images using one or more encoding parameters, which encoding parameters are determined in dependence upon the acquisition parameters associated with the plenoptic image.

The device may comprise classifying means configured to classify the plenoptic image in categories by comparing the acquisition parameters with predetermined threshold parameters defining said categories.

According to another aspect of the invention, there is provides a method for encoding a sub-aperture image of a plurality of sub-aperture images obtained from a plenoptic image, the plenoptic image being associated with acquisition parameters of a plenoptic acquisition system from which the plenoptic image has been obtained, the method comprising determining one or more encoding parameters and encoding the sub-aperture image using the determined encoding parameters, determining the encoding parameters comprising for each parameter to be determined:
determining a subset of possible encoding parameters based on the acquisition parameters; and
determining the encoding parameter to be used for encoding in the determined subset.

According to another aspect of the invention, there is provided a device for encoding a sub-aperture image of a plurality of sub-aperture images obtained from a plenoptic image, the plenoptic image being associated with acquisition parameters of a plenoptic acquisition system from which the plenoptic image has been obtained, the device comprising means configured to determine one or more encoding parameters and encoding means configured to encode the sub-aperture image using the determined parameters, the means configured to determine one or more encoding parameters comprising:
means configured to determine, for each parameter to be determined, a subset of possible encoding parameters based on the acquisition parameters; and
means configured to determine the encoding parameter to be used for encoding in the determined subset.

Other particularities and advantages of the invention will also emerge from the following description.

### BRIEF DESCRIPTION OF THE DRAWINGS

In the accompanying drawings, given by way of non-limiting examples:

FIG. 1 illustrates in a block diagram an example of processing implemented on a plenoptic video, as an example of processing in which the invention may be implemented;

FIG. 2 illustrates the general principle of a plenoptic system;

FIG. 3 schematically illustrates a plenoptic system;

FIG. 4 illustrates the principle implemented for construction of sub-aperture images;

FIG. 5 illustrates on a schematic diagram an example of process in which a method according to the invention may be implemented;

FIG. 6a illustrates on a schematic diagram an example of the main steps of one encoding scheme that may be implemented in the invention;

FIG. 6b illustrates on a schematic diagram another example of the main steps of one encoding scheme that may be implemented in the invention;

FIG. 7 illustrates on a schematic diagram the main steps of a video compression algorithm implemented in an example embodiment of the invention;

FIG. 8 illustrates on a schematic diagram some steps of an example embodiment of a method according to the invention;

FIG. 9 illustrates a first compression scheme which is used in an embodiment of the invention for a first category of plenoptic images;

FIG. 10 illustrates a second compression scheme which is used in an embodiment of the invention for some images of a second category of plenoptic images;

FIG. 11 illustrates a third compression scheme which is used in an embodiment of the invention for the other images of said second category of plenoptic images;

FIG. 12a illustrates a first example of a method of categorizing plenoptic images which may be implemented in an embodiment of the invention;

FIG. 12b illustrates on a two dimensional diagram the classification used in the method of FIG. 12a;

FIG. 13a illustrates a second example of a method of categorizing plenoptic images which may be implemented in an embodiment of the invention.

FIG. 13b illustrates on a two dimensional diagram the classification used in the method of FIG. 13a;

FIG. 14a illustrates a third example of a method of categorizing plenoptic images which may be implemented in an embodiment of the invention;

FIG. 14b illustrates on a two dimensional diagram the classification used in the method of FIG. 14a;

FIG. 15 schematically illustrates a device according to an embodiment of the invention.

### DETAILED DESCRIPTION OF EMBODIMENTS OF THE INVENTION

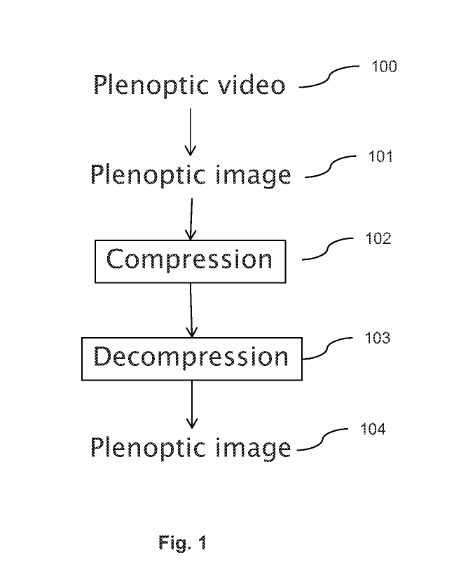

FIG. 1 illustrates in a block diagram an example of processing implemented on a plenoptic video. Such processing is an example of a process in which the invention may be implemented. Of course, the invention is not dedicated only to plenoptic video compression. The invention can also be implemented for still plenoptic image encoding.

At step 100, a plenoptic video is available. This plenoptic video is composed of several plenoptic images. At step 101, one image of this video is extracted for compression using an encoding algorithm.

At step 102, the plenoptic image extracted at step 101 is compressed by a compression algorithm. Lossy or lossless compression algorithm can be used. The elementary stream coming from this compression algorithm can be encapsulated, stored or transmitted on networks for subsequent compression.

The result of the decompression performed at step 103 is a decompressed plenoptic image available at step 104. The decompressed plenoptic image has a lower quality than the original corresponding plenoptic image extracted at step 101 due to the losses induced by a lossy compression algorithm and the possible resulting compression artefacts. The lower the compression ratio, the less the compression artefacts are present in the decompressed image. If lossless encoding is used, no artefact is visible.

In the case of processing a still image such as a plenoptic photograph instead of a video, the above described process starts at the step where a single image is available, a compression algorithm being applied to said image at step 102.

The aim of the present invention is to decrease the computation time at compression step 102 for certain plenoptic images, and thus the average computation time for compression of plenoptic images.

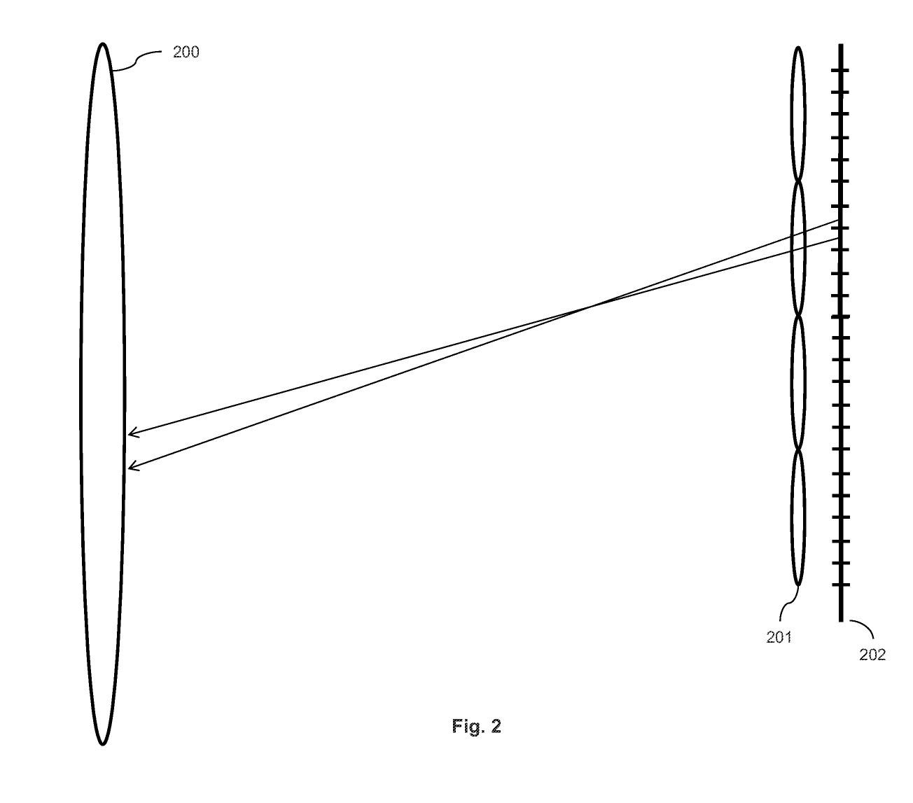

FIG. 2 illustrates very schematically the general principle of a plenoptic camera. The illustrated plenoptic camera comprises a main lens 200. In real embodiments of a camera, the main lens 200 generally comprises several lenses one behind the other. The main lens 200, represented here as a single lens, may thus comprise a group or several groups of lenses. The plenoptic camera also comprises an array of micro-lenses 201 that is located between a sensor 202 and the camera main lens 2001.

The distance between the array of micro-lenses and the sensor is equal to the focal length of the micro-lenses.

Plenoptic systems are commonly classified into two categories, generally called “Plenoptic camera 1.0” and “Plenoptic camera 2.0”. In Plenoptic camera 1.0, the array of micro-lenses is situated at the focal plane of the main lens. This enables good sampling of the orientation of the light field inside the camera. The penalty for this high sampling quality in the light field orientation is a lower spatial resolution. In plenoptic camera 2.0, the array of micro-lenses is situated so that the micro-lenses are focused on the focusing plane of the main lens. This enables a higher spatial resolution.

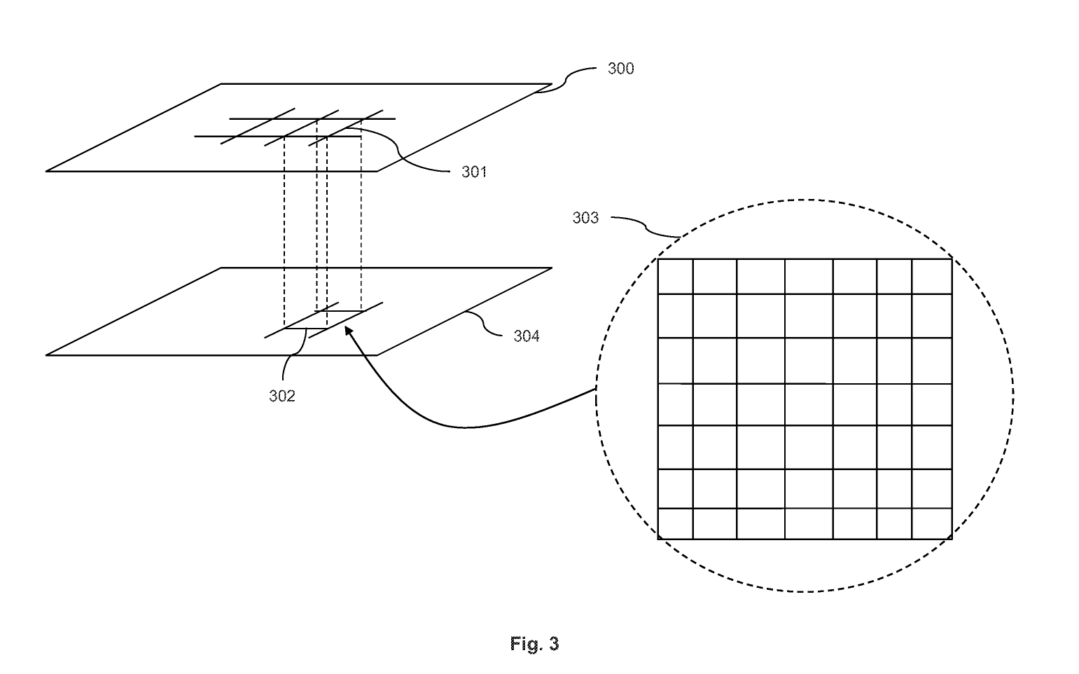

FIG. 3 illustrates a plenoptic system. As explained with reference to FIG. 1, the system comprises an array of micro-lenses 300. One micro-lens is located at a given position 301 on the array of micro lenses 300.

The sensor 303 comprises pixels. A group of pixels is located in a sensor area 302 situated under the micro-lens located at the given position 301. The distance between the sensor plane and the micro-lens array plane equals the focal length of the micro-lenses.

A detailed view of the sensor area 302 is shown on the right part of FIG. 3 (ringed view). In the represented example, the sensor area 302 comprises 49 pixels (corresponding to a 7×7 pixels array), located under a single micro-lens located at the given position 301 of the array of micro-lenses. More generally, the sensor comprises as many sensor areas as the number of micro lenses comprised on the array of micro-lenses. Each sensor area has the same pixel counts and the pixels of each sensor area have the same distribution over the sensor area.

The number of pixels constituting a sensor area depends on the camera characteristics. For a given pixel density on the sensor, the higher the number of pixels constituting a sensor area, the better the refocusing capability of the camera, but the lower the spatial resolution.

Each micro-lens thus generates a micro-lens image on a corresponding sensor area, each micro-lens image having the same shape and comprising the same pixel count, said pixels having the same disposition in each micro-lens image.

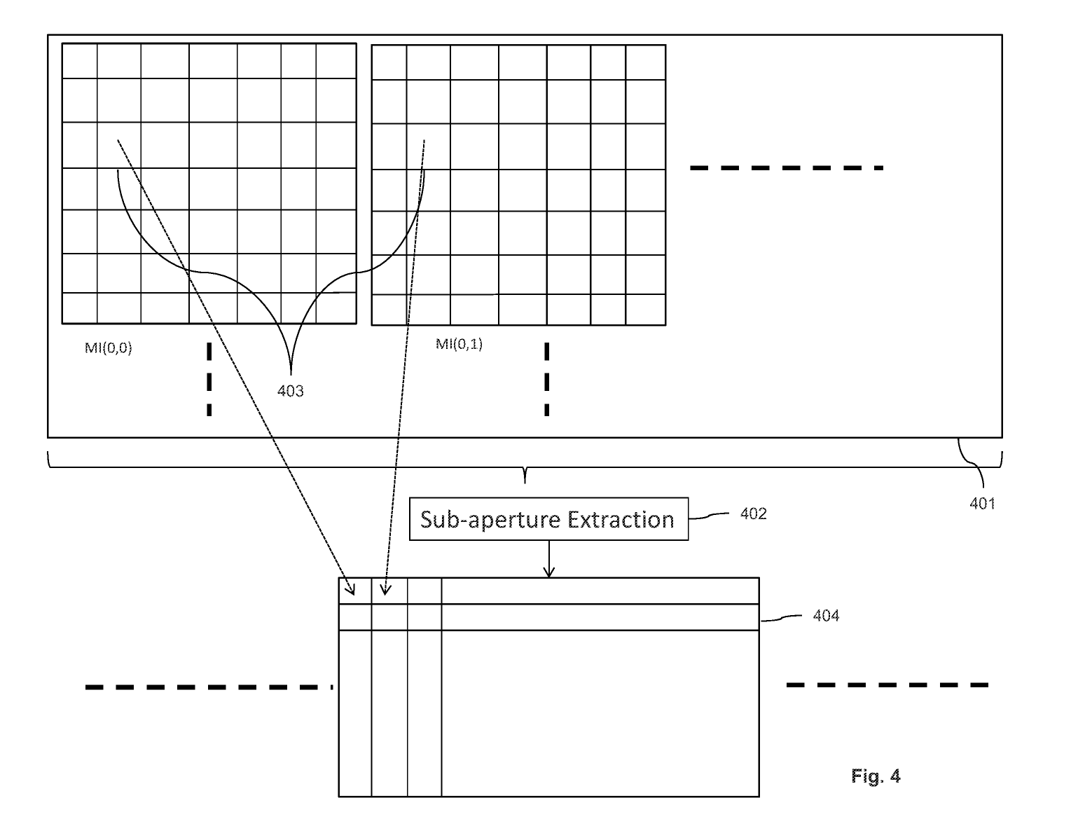

FIG. 4 illustrates the principle implemented for construction of sub-aperture images. In a general manner, a sub-aperture image corresponds to an image formed by extracting the same pixel under each micro-lens (i.e. the same pixel in each micro-lens image).

The sensor of the plenoptic camera comprises pixels. As explained with reference to FIG. 3, the pixels are associated with micro-lens images, and a micro-lens image is an image composed of the pixels under the corresponding micro-lens.

A plenoptic image is composed of a set of adjacent micro-lens images. The micro images may be designated using their coordinates in a reference associated with the micro-lens array. For example, MI(x,y) designates a micro-lens image whose coordinates (x,y) are the horizontal and vertical coordinates of the corresponding micro-lens over the micro-lens array.

For example, in FIG. 4 a plenoptic image 400 is illustrated with 2 micro-lens images 401 (in this example MI(0,0) and MI(1,0)). In the schematic illustration of this example, the sensor areas corresponding to the two micro-lens images 401 appear slightly separated: this separation does not generally exist on the actual image and sensor, and is drawn only for explanation purposes.

Each micro-lens image MI(x,y) is composed of several pixels (7×7 in the described example). The horizontal and vertical indices of the pixel for a given micro-lens may respectively be called (u,v). For example, the two given pixels 403 in FIG. 4 may be respectively denoted MI(0,0,1,2) and MI(1,0,1,2).

A sub-aperture image extraction process 402 is implemented on the plenotopic image 400. Several sub-aperture images can be created by extraction from the plenoptic image. A sub-aperture image may be called SI (for “sub-image”) and is built from all the pixels having the same coordinates (u,v) across each micro-lens image. For example, by extracting all the pixels (1,2) across the micro-lens images, the sub-aperture image 404 denoted SI(1,2) is created.

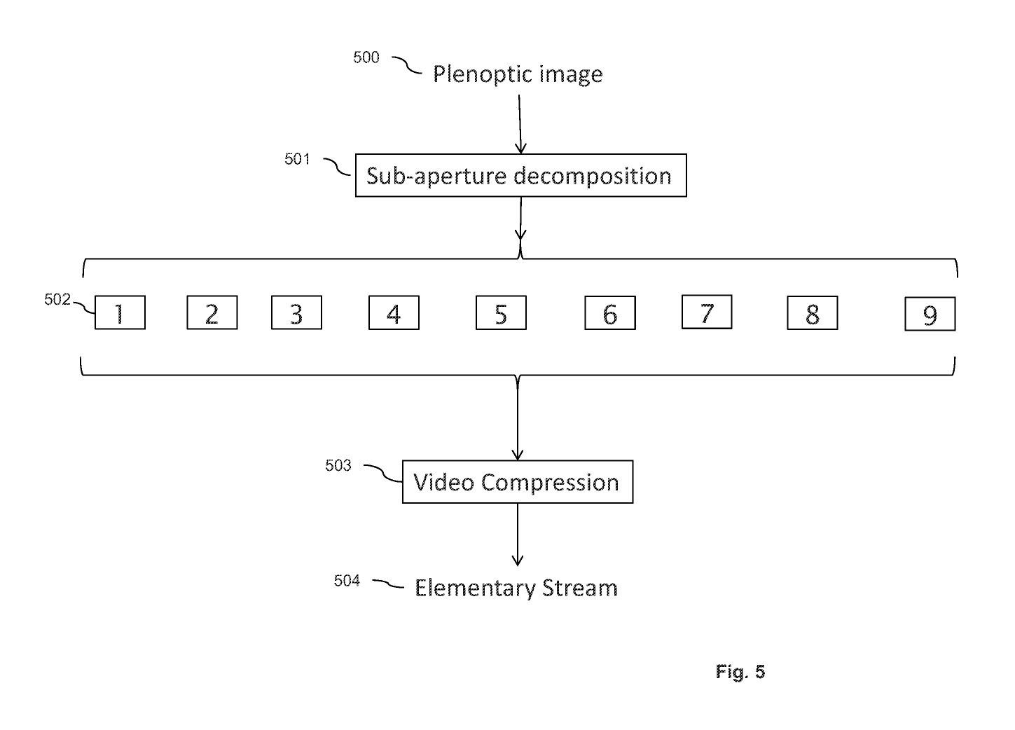

FIG. 5 illustrates on a schematic diagram an example of process in which a method according to the invention may be implemented. In other words, FIG. 5 illustrates the general context of the invention.

At step 500, a plenoptic image is available. This plenoptic image can be a still plenoptic image or one image from a plenoptic video. From this plenoptic image, sub-aperture images are extracted at step 501, according to a process as described with reference to FIG. 4.

In the represented example, an array of 3×3 pixels is situated under each micro-lens. Each micro-lens image is thus constituted by 9 pixels. At step 502, the nine sub-aperture images denoted 1 to 9 resulting from the sub-aperture extraction are available.

For encoding, the extracted sub-aperture images are considered as consecutive images of a video. Indeed, these sub-aperture images are highly correlated. Thus, they may be advantageously encoded using a video encoding scheme. If the plenoptic image available at step 500 comes from a plenoptic video, nine new images are added to the video stream enclosing the nine sub-aperture videos.

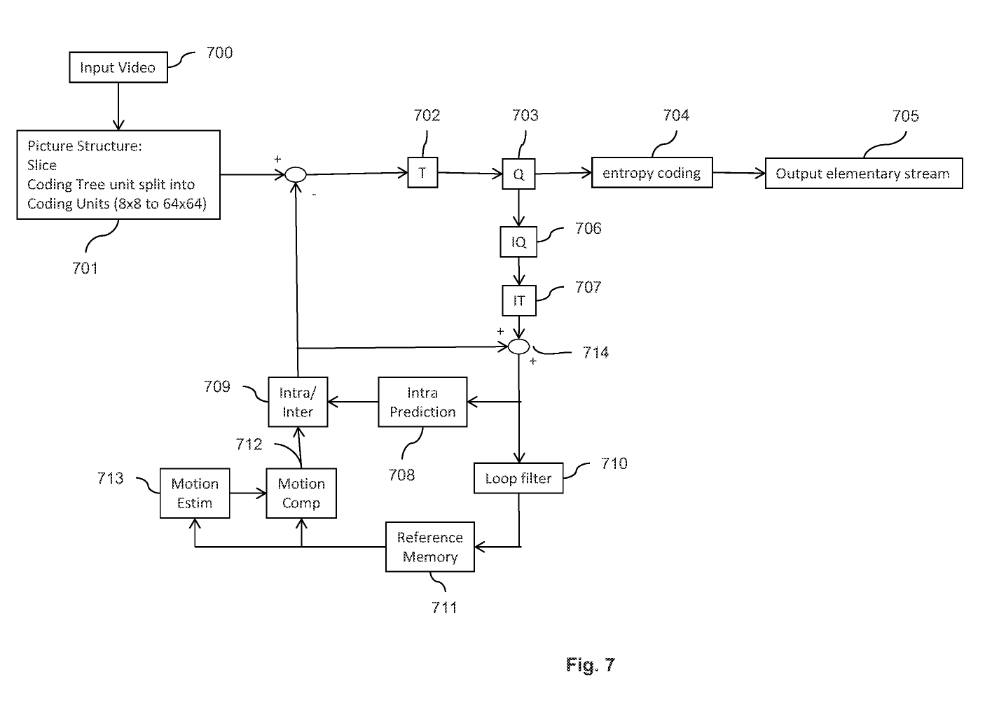

So, the nine sub-aperture images are compressed at step 503 using a video compression algorithm. This generates an elementary stream available at step 504. The nine sub-aperture images are encoded at step 503 for example according to a predictive compression scheme. For example, HEVC or MV-HEVC (for “High Efficiency Video Coding” and “Multi-view High Efficiency Video Coding”) can be used. Any other predictive scheme may also be used for encoding the nine sub-aperture images. The HEVC video compression algorithm is used at FIG. 7 to illustrate the invention.

If the plenoptic image available at step 500 was extracted from a plenoptic video, the elementary stream available at step 504 is a part of a stream corresponding to said video. The video stream is obtained by the concatenation of the elementary stream corresponding to each compressed plenoptic images of the plenoptic video.

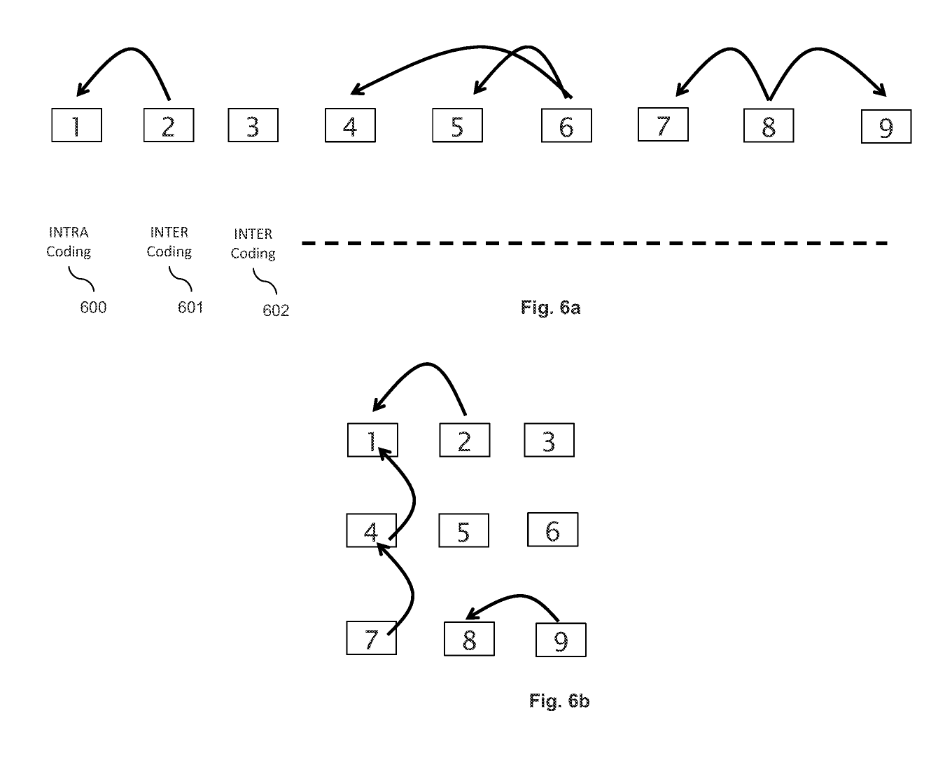

FIG. 6a describes the main steps of a compression method that can be used in the invention. In this example, nine sub-aperture images denoted 1 to 9 are illustrated. This corresponds for example to the use of a 3×3 array of pixels per micro-lens. Of course, the number of sub-aperture images could be different, depending on the number of pixels under each micro-lens.

Different predictive schemes can be used for compressing a sub-aperture image. For example, the sub-aperture images 1-9 can be encoded as INTRA images. In such a case, each sub-aperture image is self-sufficient and is encoded without references to other sub-aperture images.

Typically, the first sub-aperture image 1 can be encoded as an INTRA image at step 600. For INTRA coding, many encoding tools are known: Coding Tree Units and Coding Units representation, spatial prediction, quantization, entropy coding, and so on.

Sub-aperture images can also be encoded as predicted image using Inter Coding at step 601 and 602. In such a coding mode, the sub-aperture image (e.g. sub-aperture image 2) is encoded with reference to another sub-aperture image (e.g. sub-aperture image 1). When encoding a video, this also enables the current frame to be encoded by using a temporal prediction in addition to the spatial prediction. The sub-aperture images can also be encoded by using several reference sub-aperture frames. An example of encoding using a multi-reference scheme is illustrated: sub aperture images 4 and 5 are used for the compression of the sub-aperture image 6.

Another example is given for the encoding of sub-aperture image 8, which uses sub-aperture images 7 and 9.

Other compression schemes based on inter-layer prediction can also be used. For example a compression scheme called MV-HEVC (Multi-View High Efficiency Video Coding) may be used. The principle of such a compression scheme is illustrated in FIG. 6b. The sub-aperture images can be organized into layers. For example, three layers are defined in FIG. 6b:
Layer 1 contains the sub-aperture images 1, 2 and 3;
Layer 2 contains the sub-aperture images 4, 5 and 6;
Layer 3 contains the sub-aperture images 7, 8 and 9.

Multi-view compression algorithm like MV-HEVC enable INTRA compression, temporal compression (sub-aperture image 2 is encoded with respect to sub-aperture image 1; sub-aperture image 9 is encoded with respect to sub-aperture image 8) and inter-layer compression (sub-aperture image 4 is encoded with reference to sub-aperture image 1, sub-aperture image 7 is encoded with reference to sub-aperture image 4).

FIG. 7 illustrates on a schematic diagram the main steps of a video compression algorithms implemented in an example embodiment of the invention.

An input video is available at step 700. Such video may correspond to a set of sub-aperture images of a plenoptic image (e.g. sub-aperture images 1 to 9 in FIG. 5).

Each frame of this video (i.e. each sub-aperture image) is successively selected for being structured at step 701 into slices, Coding Tree Units (CTU) and Coding Units (CU).

The size of the Coding Units is a parameter of the compression algorithms that may be optimized when implementing the compression algorithm. The size of the Coding Unit can vary between 8×8 pixels and 64×64 pixels. Each Coding Unit is predicted either by a spatial prediction at step 708 or a motion prediction at steps 712, 713 based on stored images 711 (or images parts) that have already been compressed and decompressed.

This decompression into Coding Units is performed at step 706 and 707.

The process implemented at step 706 inverses the quantization of the residual data that has been performed at step 703. Next, at step 707 the transformation of the residual data is inversed.

Next, a summation is performed at step 714 that adds the residual to the predicted data.

Next, a post-processing filter is applied at step 710 (de-blocking filter, Sample Adaptive Offset) often called “loop filtering”.

The encoding algorithm sets at step 709 the Coding Mode of Coding Unit: INTRA coding or INTER coding. INTRA coding is performed at step 708. INTER coding is performed by motion estimation at step 713 and motion compensation at step 712.

Once the current Coding Unit is predicted, the difference between the current Coding Unit and the predicted Coding Unit is calculated for being transformed at step 702 and quantized at step 703. The final step 704 is the entropy coding 704 that enables the construction of the output elementary stream available at step 705.

Many compression parameters have to be set and may be optimized.

For example, the compression algorithm may optimize the size of the Coding Unit, and the size and partition of the Coding Units into Prediction Units. The Motion Estimation performed for INTER-coding at step 713 may be optimized by determining the best motion vectors. The compression is optimized by choosing the best coding modes between INTER and INTRA prediction.

However, such an optimization of compression requires much computation time because many compression parameters have to be tested to be set.

It is an aim of the present invention to limit this computation time, by directly setting some of the compression parameters for certain images, depending on the camera (plenoptic system) parameters when the image was taken, and which are associated with said image.

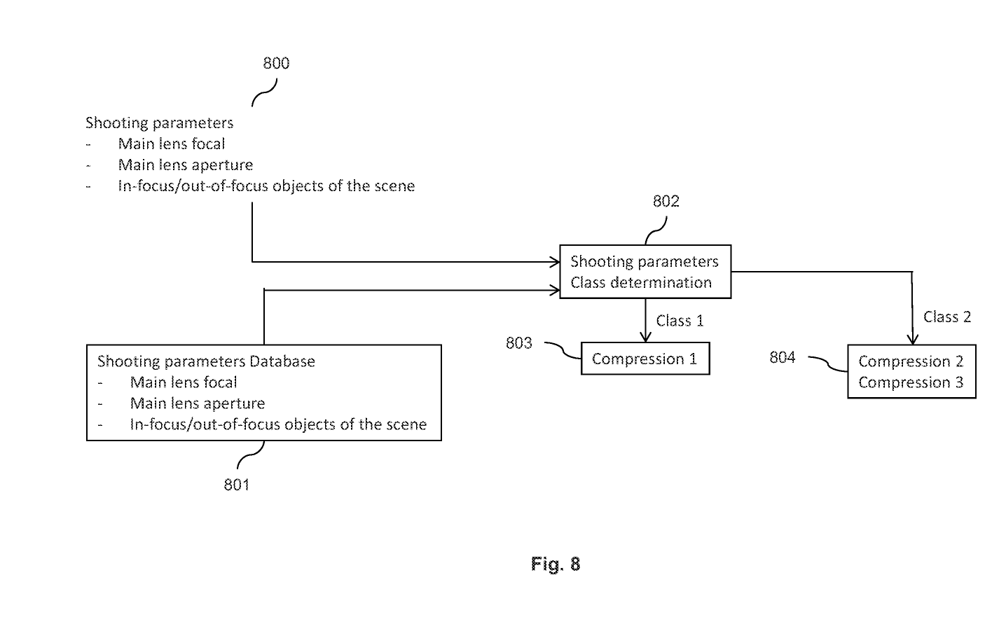

FIG. 8 illustrates on a schematic diagram some steps of an example embodiment of a method according to the invention.

A sub-aperture image or a set of sub-aperture images extracted from a plenoptic image has to be encoded. The plenoptic image has been taken with a plenoptic system using some acquisition parameters (e.g. a lens focal length, an aperture, etc). The acquisition parameters of the plenoptic system are associated with the plenoptic image.

At step 800, the acquisition parameters of the plenoptic acquisition system (e.g. camera/lens) are read. These parameters may be read from the camera, or read from a file (e.g. the EXIF file) associated with the image/video.

For example, the acquisition parameters may include the focal length of the main lens or/and the main lens aperture or/and some parameters read from the autofocus system of the camera (e.g. the distance between the camera and the image focal plane, i.e. the in-focus object of the scene).

These acquisition parameters are compared at step 802 to predefined corresponding parameters of a training database read at step 801. The training data-base may define, as in the illustrated example, two image categories or classes (namely “class 1” and “class 2”) that are related to the camera parameters.

In this example of embodiment, the plenoptic image is classified at step 802 either in a first category denoted “class 1” or in a second category denoted “class 2”, based on the acquisition parameters of the current image to encode.

If it is determined at step 802 that the image belongs to “class 1”, a first compression algorithm (denoted “compression 1”) is performed at step 803. If it is determined at step 802 that the image belongs to “class 2”, a second compression algorithm (denoted compression 2) or a third compression algorithm (denoted compression 3) is performed at step 804.

The first, second and third compression algorithms are based on the same codec. However, only the compression parameters and the way they are determined differ in these three algorithms.

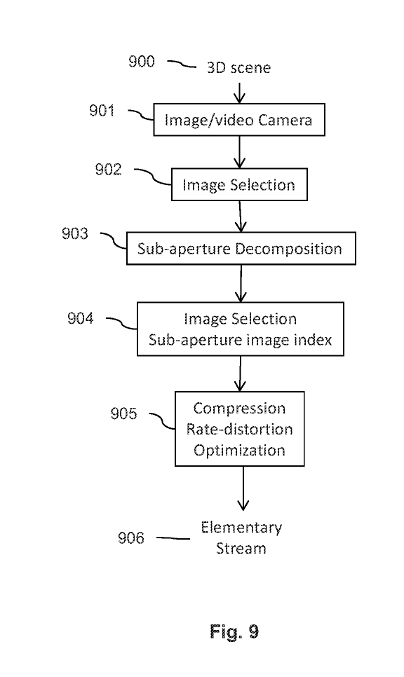

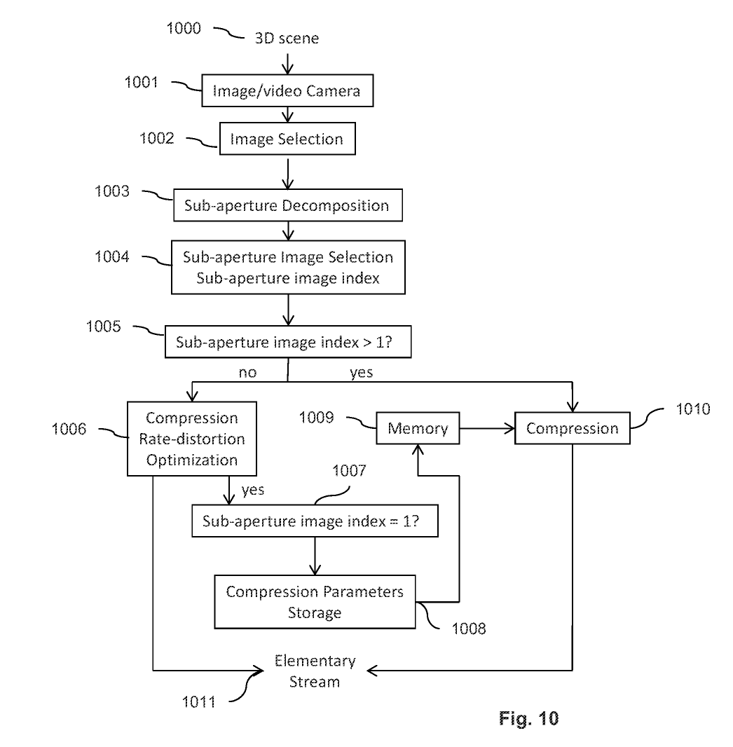

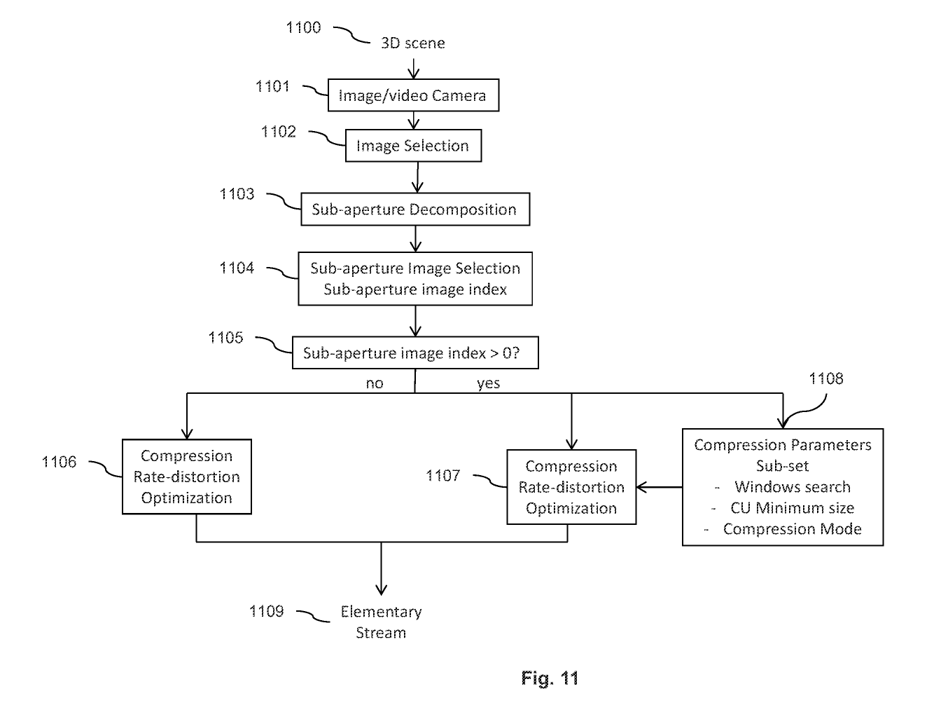

The first compression algorithm is described in FIG. 9. The second compression algorithm is described in FIG. 10. The third compression algorithm is described in FIG. 11.

As will be hereafter detailed with reference to these Figures, the difference between these algorithms is the way the compression parameters are determined.

In broad terms, in the first algorithm all the compression parameters are optimized (i.e. determined to be set at the optimal value or setting) for each sub-aperture image. In the second algorithm, some of the compression parameters are not optimized for each sub-aperture image: compression parameters determined (i.e. optimized) for a previous sub-aperture image are directly used. In the third algorithm, the compression parameters are optimized, for some sub-aperture images, in a limited optimization range.

Thus, in the illustrated embodiment example, at step 803 an algorithm with a complete optimization of the compression parameters is performed, while at step 804 an algorithm with a partial optimization of the compression parameters is performed, either by setting some of the compression parameters directly according to the corresponding compression parameters used for previously encoded sub-aperture images, and/or by limiting the optimization range of some compression parameters.

FIG. 9 illustrates a first compression scheme which may be used, in a particular embodiment of the invention, for encoding plenoptic images of the first category (class 1).

A step 900, an image of a three dimensional scene is taken using a plenoptic camera (or more generally a plenoptic system) providing either a still plenoptic image or a plenoptic video made available at step 901. One plenoptic image is selected 902 for being compressed. This image is decomposed at step 903 into sub-aperture images, as illustrated in relation with FIG. 4.

Each sub-aperture image is selected at a selection step 904 for being compressed at step 905 using an encoding algorithm which is a video compression algorithm.

The encoding algorithm contains rate-distortion optimization to select optimized compression parameters.

For example, as has been described with reference to FIG. 7, the algorithm defines:
an optimized partition of the Coding Tree units into Coding units; and/or
an optimized partition of the Coding Units into Prediction Units; and/or
optimized Coding Modes for each Coding Units (INTER/INTRA); and/or
optimized motion vectors.

During optimization of the motion vectors, a search window is defined. The size of the search window is generally quite large to make it possible to take potential substantial motion between successive images into account. Once the sub-aperture image is compressed, the new sub-aperture image is selected.

In the illustrated example, the sub-aperture images are encoded one after another, in a given order. However, any order can be used for compressing the sub-aperture images.

FIG. 10 illustrates a second compression scheme which may be used, in a particular embodiment of the invention, for encoding plenoptic images of the second category (class 2).

A step 1000, an image of a three dimensional scene is taken using a plenoptic camera (or more generally a plenoptic system) providing either a still plenoptic image or a plenoptic video made available at step 1001. One plenoptic image is selected 1002 for being compressed. This image is decomposed at step 1003 into sub-aperture images, as illustrated in relation with FIG. 4.

Each sub-aperture image is selected at a selection step 1004 for compression at step 1006 or step 1010 using an encoding algorithm which is a video compression algorithm. The same compression algorithm is implemented at step 1006 and step 1010.

An index is associated with the sub-aperture images. For example, the first compressed sub-aperture image may be associated with the index “0”, and each subsequent selected sub-aperture image may be associated with an incremented index (e.g. increment by 1 for each new sub-aperture image: the second selected sub-aperture image is associated with the index “1”, and so on).

At step 1005, the index of the current selected sub-aperture image is read. If the index is 0 or 1, a compression is performed at encoding step 1006. Encoding step 1006 is similar to step 905 of FIG. 9. The encoding algorithm performed at step 1006 contains rate-distortion optimization to select optimized compression parameters.

For example, as it has been described with reference to FIG. 7, the algorithm defines:
an optimized partition of the Coding Tree units into Coding units; and/or
an optimized partition of the Coding Units into Prediction Units; and/or
optimized Coding Modes for each Coding Units (INTER/INTRA); and/or
optimized motion vectors.

Once the sub-aperture image has been encoded, the elementary stream is updated at step 1011.

Just after the compression, it is assessed whether the index of the current sub-aperture image is “1”.

If the index of the current sub-aperture image is “1”, the compression parameters determined for the compression performed at step 1006 are stored in the memory at step 1009. Examples of parameters that can be stored are:
the partition of the Coding Tree units into Coding Units; and/or
the partition of the Coding Units into Prediction Units; and/or
the Coding Modes for each Coding Unit (INTER/INTRA); and/or
the maximum amplitude of the motion vectors calculated during compression.

Next, if the index of the current sub-aperture image read at step 1005 is greater than 1, the compression algorithm of step 1010 (which is the same as at step 1006) is performed to encode said current sub-aperture image, using the compression parameters stored at step 1009.

Therefore, during compression:
the stored partition units are used; and/or
the stored prediction units are used; and/or
and/or the stored coding modes are used; and/or
and/or the search window can be set to the stored maximum amplitude of the motion vectors.

By reusing the stored compression parameters, the determination of “optimized” compression parameters is simplified, and computation times are reduced.

FIG. 11 illustrates another (“third”) compression scheme which may be used, in a particular embodiment of the invention, for encoding plenoptic images of the second category (class 2).

A step 1100, an image of a three dimensional scene is taken using a plenoptic camera (or more generally a plenoptic system) providing either a still plenoptic image or a plenoptic video made available at step 1101. One plenoptic image is selected 1102 for compression. This image is decomposed at step 1103 into sub-aperture images, as illustrated in relation with FIG. 4.

Each sub-aperture image is selected at a selection step 1104 for compression at step 1106 or step 1107 using an encoding algorithm which is a video compression algorithm. The same compression algorithm is implemented at step 1106 and step 1107.

An index is associated with the sub-aperture images. The first compressed sub-aperture image is associated with the index “0”, second selected sub-aperture image is associated with the index “1”, and so on.

At step 1105, the index of the current selected sub-aperture image is read. If the index is 0, a compression is performed at encoding step 1106. Encoding step 1106 is similar to step 905 of FIG. 9. The encoding algorithm performed at step 1106 contains rate-distortion optimization to select optimized compression parameters.

For example, as has been described with reference to FIG. 7, the algorithm defines:
an optimized partition of the Coding Tree units into Coding units; and/or
an optimized partition of the Coding Units into Prediction Units; and/or
optimized Coding Modes for each Coding Units (INTER/INTRA); and/or
optimized motion vectors.

Once the sub-aperture image has been encoded, the elementary stream is updated at step 1109.

If the index of the current sub-aperture image read at step 1105 is greater than 0, some compression parameters to be used by the compression algorithm performed at step 1107 are set at step 1108 without implementing an optimization procedure (i.e. according to predefined settings or values), or with a restricted procedure (i.e. optimizing the parameters in a predefined range or a limited set of values). For example:
the search window used for calculating the motion vectors can set to a small value (e.g. 0 or 1 pixels). If 0 is chosen, no motion vector estimation is performed, and the motion is always set to 0; and/or
the compression modes can be directly set to the INTER prediction mode (or the compression algorithm will not test the INTRA prediction mode for compression); and/or
the minimum size of the Coding Units can be set at a high value (or the smallest possible sizes of Coding Units, e.g. 8×8 or 16×16, are not tested for encoding); and/or
the Coding Unit maximum size can be set at a low value (or the biggest possible sizes of Coding Units, e.g. 64×64, are not tested for encoding).

By determining the compression parameters in a limited set of possible values (or settings), or by setting these compression parameters to predefined values or settings, the computation times to determine the compression parameters are reduced.

Because the determination of compression parameters as described with reference to FIG. 10 or 11 is performed for an a category of plenoptic images with specific characteristics (e.g. detected from the camera parameters as “class 2” images (804) as shown in FIG. 8), the obtained compression ratio is close to what would be obtained when using an algorithm in which all compression parameters are fully optimised (as described with reference to FIG. 9).

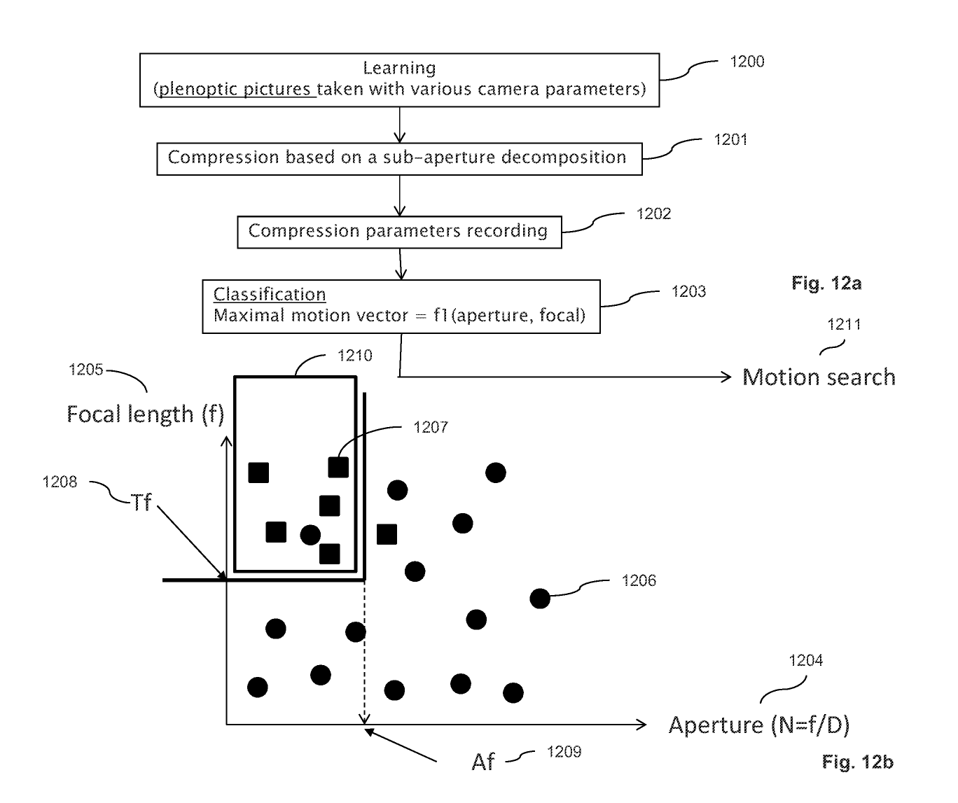

The compression parameters (e.g. motion search windows, maximum Coding Unit Size, minimum Coding Unit Size, ‘forbidden’ Compression Mode) can be learned from a training stage. Such a training stage is illustrated in FIGS. 12, 13 and 14.

FIG. 12a illustrates a first example of a training method for obtaining classification data which can subsequently be used for categorizing plenoptic images. The ultimate aim of this method is to be able to categorize the plenoptic images in two categories (class 1 or class 2 as described with reference to FIG. 8).

The classification is based on an off-line training process, i.e. based on the results of an empirical process performed to define the method according the illustrated example embodiment of the invention. The result of the training process may be a shooting parameters database or training database, which is used for example as an input of the method illustrated in FIG. 8, at step 801.

At step 1200, a predefined number of images are taken with a plenoptic acquisition system (e.g. a plenoptic camera) to form a training set.

These images are taken with various acquisition parameters (e.g. focal length, main lens aperture). Each image is compressed using a compression algorithm, for example HEVC compression algorithm. The compression algorithm is the same as the one used at steps 1106 and 1107 of FIG. 11, the same as the one used at steps 1006 and 1010 of FIG. 10 and, the same as the one used at step 905 of FIG. 9, and the same as the one described in FIG. 7.

Before compression, the plenoptic image is decomposed at step 1201 into sub-aperture images. When compression is performed, the compression parameters and the camera parameters are recorded at step 1202.

In the illustrated example, the recorded compression parameter is the maximum absolute value of a motion vector component, among all the motion vectors components generated during the compression stage. This maximum absolute value available at step 1211 is called Motion Search or MS.

In the illustrated example, the recorded acquisition parameters are
the focal lenght of the plenoptic acquisition system; and
the aperture of the plenoptic acquisition system (aperture of the main lens or group of lenses).

Next, a classification algorithm is performed at step 1203 to categorize the images of the training set. For example, a tree-based classification can be used e.g. CART (Classification and Regression Tree) method. Other classification algorithms, such as a visual classification, may be used.

To categorize the images, for each plenoptic image of the training set, the recorded Motion Search is compared with a predefined threshold (for instance, a threshold of 1 may be used).

An example of such a classification is illustrated on a two dimensional diagram in FIG. 12b. The horizontal axis 1204 represents the aperture of the camera associated with an image. The vertical axis 1205 represents the focal length of the main lens used to take the image. The images are located on this diagram according to the aperture and focal length associated with said images. The images having an MS lower than 1 are represented by circles 1206. The images having an MS higher than or equal to 1 are represented by squares 1207.

Two regions are determined on the diagram. The regions are defined by a focal length threshold 1208 denoted Tf and an aperture threshold 1209 denoted Af.

The regions are determined according to the distribution of the circles and squares (images having an MS lower than 1 and images having an MS higher than or equal to 1)

The region 1210 defined to contain most of the squares is associated with the first category of images, the class 1 used in FIG. 8. The remaining part of the diagram is associated with the second category of images, the class 2.

Therefore, when using such a classification in a method as described with reference to in FIG. 8, the focal length and aperture used for taking an image are used at step 802 to determine to which one of these two regions the image belongs, and so determine the classification of the image into Class 1 or Class 2.

The Motion Search may be calculated according to another method. In this method, a motion estimation algorithm is performed to estimate the motion between the sub-aperture images. This motion estimation algorithm may be an optical flow computation algorithm. Once the motion has been calculated for each pixel, the maximum absolute value among the all the motion vectors components is determined. This value is taken as Motion Search (MS).

To sum up, a possible classification step 802 performed in a method according to FIG. 8 may comprise:
Storing in memory a current image to be compressed;
Determining acquisition parameters, namely the focal length and the aperture, directly from a plenoptic system or in a file associated with the image (e.g. EXIF file);
Based on these acquisition parameters, classifying the current image into a category according to a method as described with reference to FIGS. 12a and 12b.

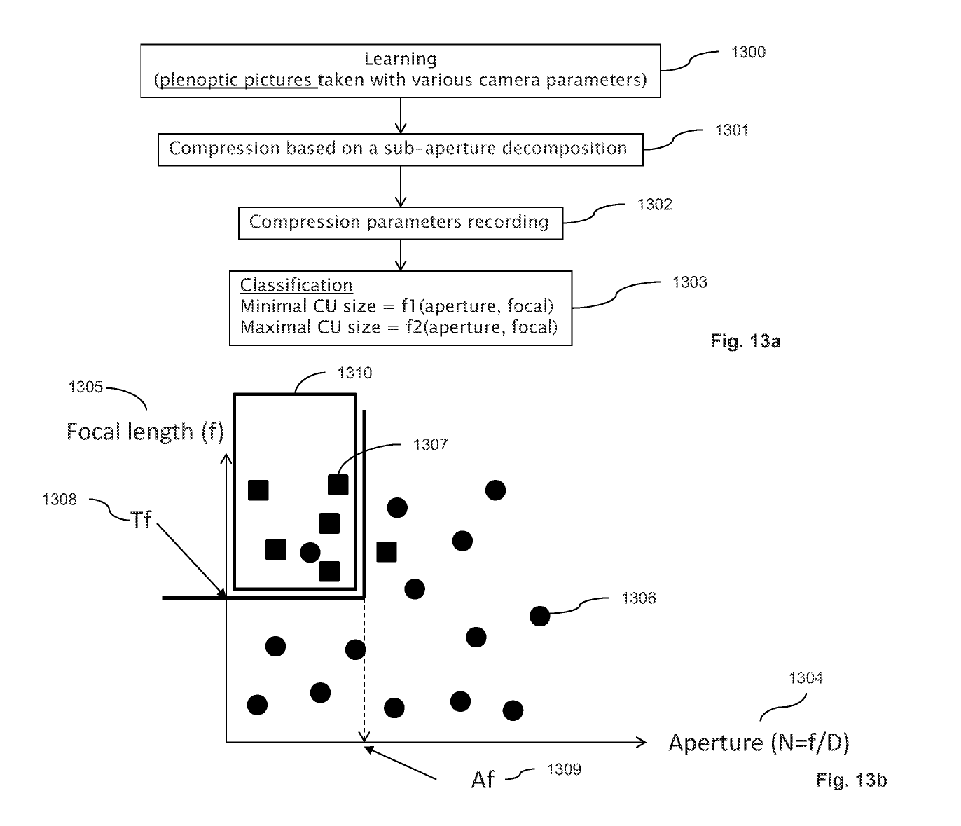

FIG. 13a illustrates a second example of a method of categorizing plenoptic images which may be implemented in an embodiment of the invention

As in the method described with reference to FIG. 12a, the classification described with reference to FIG. 13a is based on an off-line training process, i.e. based on the results of an empirical process performed to define the method according the illustrated example embodiment of the invention. The result of the training process may be a shooting parameters database or training database, which is used for example as an input of the method illustrated in FIG. 8, at step 801.

At step 1300, a predefined number of images are taken with a plenoptic acquisition system (e.g. a plenoptic camera) to form a training set.

These images are taken with various acquisition parameters (e.g. focal length, main lens aperture). Each image is compressed using a compression algorithm, for example HEVC compression algorithm. The compression algorithm is the same as the one used at steps 1106 and 1107 of FIG. 11, the same as the one used at steps 1006 and 1010 of FIG. 10 and, the same as the one used at step 905 of FIG. 9, and the same as the one described in FIG. 7.

Before compression, the plenoptic image is decomposed at step 1301 into sub-aperture images. When compression is performed, the compression parameters and the camera parameters are recorded at step 1302.

In the illustrated example, the recorded compression parameters are:
the minimum Coding Unit size among all the Coding Units calculated during compression. This value is denoted CUMin; and
the maximum Coding Unit size among all the Coding Units calculated during compression. This value is denoted CUMax.

In the illustrated example, the recorded acquisition parameters are:
the focal length of the plenoptic acquisition system; and
the aperture of the plenoptic acquisition system (aperture of the main lens or group of lenses).

Next, a classification algorithm is performed at step 1303 to categorize the images of the training set. For example, a tree-based classification can be used e.g. CART (Classification and Regression Tree) method. Other classification algorithms, such as a visual classification, may be used.

To categorize the images, for each plenoptic image of the training set, the minimum and maximum sizes of the Coding Units (respectively denoted CUMin and CUMax) are compared with thresholds m and M.

An example of such a classification is illustrated on a two dimensional diagram in FIG. 13b.

The horizontal axis 1304 represents the aperture of the camera associated with an image. The vertical axis 1305 represents the focal length of the main lens used to take the image. The images are located on this diagram according to the aperture and focal length associated with said images. The images for which CUMin is greater than m and CUMax is less than M are represented by circles 1306. The images for which CUMin is less than or equal to m or CUMax greater than or equal to M are represented by squares 1307.

Two regions are determined on the diagram. The regions are defined by a focal length threshold 1308 denoted Tf and an aperture threshold 1309 denoted Af.

The regions are determined according to the distribution of the circles and squares.

The region 1310 defined to contain most of the squares is associated with the first category of images, the class 1 used in FIG. 8. The remaining part of the diagram is associated with the second category of images, the class 2.

Therefore, when using such a classification in a method as described with reference to in FIG. 8, the focal length and aperture used for taking an image are used at step 802 to determine to which one of these two regions the image belongs, and so determining the classification of the image into Class 1 or Class 2.

To sum up, a possible classification step 802 performed in a method according to FIG. 8 may comprise:
Storing in memory a current image to be compressed;
Determining acquisition parameters, namely the focal length and the aperture, directly from a plenoptic system or in an file associated to the image (e.g. EXIF file);
Based on these acquisition parameters, classifying the current image into a category according to a method as described with reference to FIGS. 13a and 13b (e.g. class 1 or class 2).

FIGS. 13a and 13b illustrate a classification based on the minimum and maximal CU size. Of course, only one of these two parameters could be used during the classification stage (e.g. classification based on CU min).

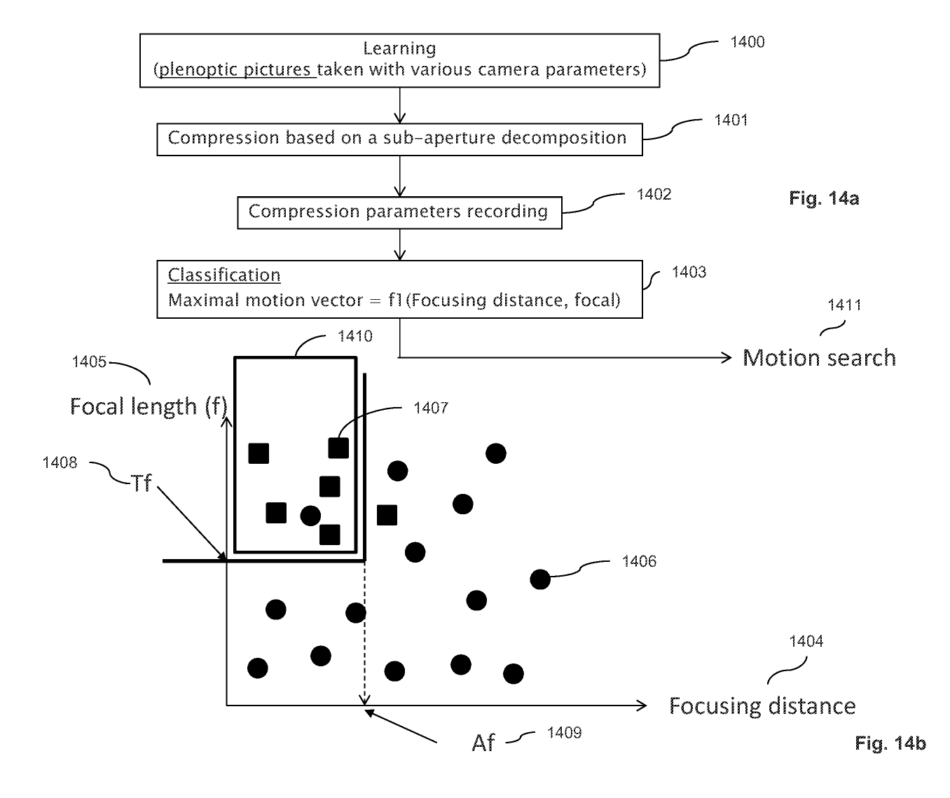

FIG. 14a illustrates a third example of a method of categorizing plenoptic images which may be implemented in an embodiment of the invention.

As in the methods described with reference to FIGS. 12a and 13a, the classification described with reference to FIG. 14a is based on an off-line training process, i.e. based on the results of an empirical process performed to define the method according the illustrated example embodiment of the invention. The result of the training process may be a shooting parameters database or training database, which is used for example as an input of the method illustrated in FIG. 8, at step 801.

At step 1400, a predefined number of images are taken with a plenoptic acquisition system (e.g. a plenoptic camera) to form a training set.

These images are taken with various acquisition parameters (e.g. focal length, main lens aperture). Each image is compressed using a compression algorithm, for example HEVC compression algorithm. The compression algorithm is the same as the one used at steps 1106 and 1107 of FIG. 11, the same as the one used at steps 1006 and 1010 of FIG. 10 and, the same as the one used at step 905 of FIG. 9, and the same as the one described in FIG. 7.

Before compression, the plenoptic image is decomposed at step 1401 into sub-aperture images. When compression is performed, the compression parameters and the camera parameters are recorded at step 1402.

In the illustrated example, the recorded compression parameter is the maximum absolute value of a motion vector component, among all the motion vector components generated during the compression stage. This maximum absolute value available at step 1411 is called Motion Search or MS.

In the illustrated example, the recorded acquisition parameters are:
the focal length of the plenoptic acquisition system; and
the distance of the focusing plane from the main lens when taking the image.

Next, a classification algorithm is performed at step 1203 to categorize the images of the training set. For example, a tree-based classification can be used e.g. CART (Classification and Regression Tree) method. Other classification algorithms, such as a visual classification, may be used.

To categorize the images, for each plenoptic image of the training set, the recorded Motion Search is compared with a predefined threshold (for instance, a threshold of 1 may be used).

An example of such a classification is illustrated in a two dimensional diagram in FIG. 14b. The horizontal axis 1404 represents the focusing distance (distance of the focusing plane) associated with an image. The vertical axis 1405 represents the focal length of the main lens used to take the image. The images are located on this diagram according to the focusing distance and focal length associated with said images. The images having an MS lower than 1 are represented by circles 1406. The images having an MS higher than or equal to 1 are represented by squares 1407.

Two regions are determined in the diagram. The regions are defined by a focal length threshold 1408 denoted Tf and an aperture threshold 1409 denoted Af.

The regions are determined according to the distribution of the circles and squares (images having a MS lower than 1 and images having a MS higher than or equal to 1).

The region 1410 defined to contain most of the squares is associated with the first category of images, the class 1 used in FIG. 8. The remaining part of the diagram is associated with the second category of images, the class 2.

Therefore, when using such a classification in a method as described with reference to in FIG. 8, the focusing distance and aperture used for taking an image are used at step 802 to determine to which one of these two regions the image belongs, and so determine the classification of the image into Class 1 or Class 2.

As previously described, other methods to determine the Motion Search may be used for such a classification of the images.

To sum up, a possible classification step 802 performed in a method according to FIG. 8 may comprise:
storing in memory a current image to be compressed;
determining acquisition parameters, namely the focusing distance and the aperture, directly from a plenoptic system or in a file associated with the image (e.g. EXIF file);
based on these acquisition parameters, classifying the current image into a category according to a method as described with reference to FIGS. 14a and 14b (e.g. class 1 or class 2).

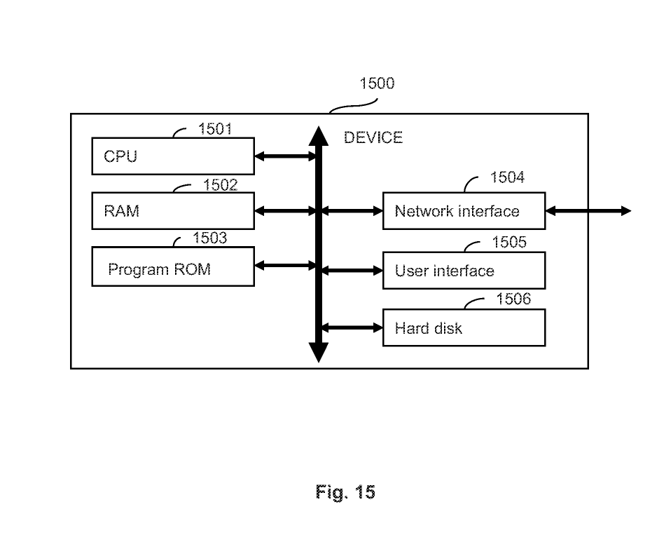

FIG. 15 schematically represents a device according to an embodiment of the invention.

In the illustrated embodiment, the device 1500 comprises a central processing unit (CPU) 1501 capable of executing instructions from program ROM 1503 on powering up of the device, and instructions relating to a software application from main memory 1502 after the powering up.

The main memory 1302 is for example of Random Access Memory (RAM) type. The memory capacity can be expanded by an optional RAM extension connected to an expansion port (not illustrated).

Instructions relating to the software application may be loaded into the main memory 1302 from the hard-disk (HD) 1506 or the program ROM 1503 for example. Such a software application, when executed by the CPU 1501, causes an embodiment of a method for encoding a plenoptic image according to the invention to be performed.

A network interface 1504 may allow the connection of the device to a communication network. The software application when executed by the CPU may thus receive data from other devices through the network interface.

A user interface 1505 may allow information to be displayed to a user, and/or inputs to be received from a user.

The present invention thus provides a method and device that allow optimized encoding (and in particular compression) of plenoptic images or video.

More particularly, by setting some compression parameters to predefined values or stings for some images identified as belonging to a particular category, and/or by determining some compression parameters in a limited range of possible values, the total computation time for encoding a group of plenoptic images may be reduced.

Although the present invention has been described hereinabove with reference to specific embodiments, the present invention is not limited to the specific embodiments, and modifications will be apparent to a person skilled in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encoding a plenoptic image comprising a plurality of microlens images, each microlens image formed by an associated microlens,
the plenoptic image being associated with acquisition parameters of a plenoptic acquisition system with which the plenoptic image has been obtained,
the method comprising;
decomposing the plenoptic image into a plurality of sub-aperture images, and
encoding the plurality of sub-aperture images using one or more encoding parameters, which one or more encoding parameters are determined-in dependence upon the acquisition parameters associated with the plenoptic image.

2. The method according to claim 1, comprising classifying the plenoptic image into one of a plurality of categories by comparing the acquisition parameters with predetermined threshold parameters defining the categories.

3. The method according to claim 2, wherein a first category is defined and wherein the sub-aperture images of a plenoptic image of the first category are encoded using a rate-distortion optimization process to determine encoding parameters.

4. The method according to claim 2, wherein a second category is defined and wherein at least one sub-aperture image of a plenoptic image of the second category is encoded using a restricted sub-set of encoding parameters.

5. The method according to claim 4, wherein the sub-aperture images corresponding to a plenoptic image are indexed to be encoded in an order defined by the index, and at least one sub-aperture image is encoded using encoding parameters determined for a lower indexed, sub-aperture image.

6. The method according to claim 5, wherein the lower indexed, sub-aperture image is encoded using a rate-distortion optimization process to determine encoding parameters.

7. The method according to claim 5, wherein the lower indexed, sub-aperture image is the second indexed sub-aperture image.

8. The method according to claim 5, wherein sub-aperture images are indexed to be encoded in an order defined by the index, and the first indexed, sub-aperture image is encoded using a rate-distortion optimization process to determine encoding parameters from a set of possible parameters, and wherein at least one higher indexed, sub-aperture image is encoded using parameters selected from a restricted sub-set of the possible parameters.

9. The method according to claim 2,
wherein determining the one or more encoding parameters comprises for each parameter to be determined:
determining, based on the category to which the plenoptic image belongs, a sub-set of possible encoding parameters based on the acquisition parameters; and
determining the encoding parameter to be used for encoding in the determined subset.

10. The method according to claim 1, wherein the encoding parameter comprises the size of a search area for motion estimation.

11. The method according to claim 1, wherein the sub-aperture images are encoded in blocks of pixels, a determined encoding parameter comprising an encoding mode of the blocks of pixels.

12. The method according to claim 1, wherein pixel blocks are independently encoded, a determined encoding parameter comprising a size of the blocks of pixels.

13. The method according to claim 11, wherein the block of pixels is a prediction unit.

14. The method according to claim 11, wherein the block of pixels is a coding unit.

15. The method according to claim 1, wherein the acquisition parameters comprise an aperture of a lens of the acquisition system.

16. The method according to claim 15, wherein the acquisition parameters comprise a focal length of a lens of the acquisition system.

17. The method according to claim 15, wherein the acquisition parameters comprise a distance of a focusing plane from the acquisition system.

18. The method according to claim 17, wherein the distance value of the focusing plane is determined using information provided by a camera autofocus system.

19. A device for encoding a plenoptic image comprising a plurality of microlens images, each microlens image formed by an associated microlens, the plenoptic image being associated with acquisition parameters of a plenoptic acquisition system with which the plenoptic image has been obtained,
the device comprising:
means configured to decompose the plenoptic image into a plurality of sub-aperture images, and
means configured to encode the plurality of sub-aperture images using one or more encoding parameters, which one or more encoding parameters are determined-in dependence upon the acquisition parameters associated with the plenoptic image.

20. A method for encoding a sub-aperture image of a plurality of sub-aperture images obtained from a plenoptic image,
the plenoptic image being associated with acquisition parameters of a plenoptic acquisition system from which the plenoptic image has been obtained,
the method comprising;
determining one or more encoding parameters and encoding the sub-aperture image using the determined encoding parameters,
wherein the determining of the one or more encoding parameters comprises for each parameter to be determined:
determining a subset of possible encoding parameters based on the acquisition parameters; and
determining the encoding parameter to be used for encoding in the determined subset.
